(19) United States
(12) Patent Application Publication
(10) Pub. No.: US 2011/0088091 A1
(43) Pub. Date: Apr. 14, 2011

(54) METHODS AND APPARATUS TO MAINTAIN VALIDITY OF SHARED INFORMATION

(76) Inventors: Dejan Petronijevic, Mississauga (CA); Viera Bibr, Mississauga (CA); Michael Shenfield, Mississauga (CA); Matthew Bells, Waterloo (CA); James Godfrey, Waterloo (CA); Farhoud Shirzadi, Waterloo (CA); Laura Brindusa Fritsch, Redwood City, CA (US)

(21) Appl. No.: 12/817,954

(22) Filed: Jun. 17, 2010

Related U.S. Application Data
(60) Provisional application No. 61/218,787, filed on Jun. 19, 2009.

(51) Int. Cl. G06F 17/24; G06F 21/00

(52) U.S. Cl. 726/21; 715/234

(57) ABSTRACT

Example methods and apparatus to maintain validity of shared information are disclosed. A disclosed example method involves receiving a communication requesting an extensible markup language (XML) document from an XML document management client associated with a principal. In addition, the example method involves generating a subset of the XML document for the principal such that validity of the subset is ensured by including all document parts required according to an XML schema despite the principal having access rights to only certain parts of the XML document but not other parts. The other parts are included in the subset without values.

### RELATED APPLICATIONS

This Patent claims the benefit of U.S. Provisional Patent Application No. 61/218,787, filed on Jun. 19, 2009, which is hereby incorporated herein by reference in its entirety.

### FIELD OF THE DISCLOSURE

The present disclosure relates generally to network communications and, more particularly, to methods and apparatus to maintain validity of shared information.

### BACKGROUND

Standardized document formats are often used to define how documents are created and how information is stored and maintained therein. An example of such a standardized document format is the extensible markup language (XML) standard. The Open Mobile Alliance (OMA) is a group that defines XML Document Management (XDM) for use in distributed access. For example, an OMA XDM enabler defines mechanisms for manipulating user-specific, service-related information stored in XML documents on servers. Such information is typically stored in the network where it can be located, accessed and manipulated (e.g., created, changed, and/or deleted). The XDM specifications specify how such information should be defined in XML documents. In addition, the XDM specifications specify a common protocol for accessing and manipulating such XML documents.

As is known, XML documents can be employed for many different types of uses. Some of those uses are application specific (e.g., such as storing subscriber preferences for a particular enabler (e.g., a Presence Subscription Policy or push-to-talk-over-cellular (PoC) Groups), and others are not application specific (e.g., storing a list of uniform resource identifiers (URIs), such as a list of friends, that can be re-used from multiple enablers).

In some instances, XDM can be used to facilitate authorizing individuals to access presence information for other individuals. In addition, XDM can be used to facilitate session initiation of many individuals to the same conference call. In such instances, there are common usages which are shared across multiple OMA enablers. For example, a URI list defined within a presence enabler could be used to initiate a conference call between an online group of friends.

### BRIEF DESCRIPTION OF THE DRAWINGS

FIG. 1 depicts example user equipment clients requesting access to a shared document.

FIG. 2 depicts the example user equipment clients of FIG. 1 accessing respective views of the shared document of FIG. 1.

FIG. 3 depicts an example network system in which the example user equipment clients of FIGS. 1 and 2 can access shared information stored in the network system.

FIG. 4 depicts an example document management system to enable the example user equipment clients of FIGS. 1-3 to access shared information stored in the network system of FIG. 3.

FIG. 5 depicts an example logical storage structure that can be used to store shared documents in the network system of FIG. 3.

FIG. 6 depicts an example technique that can be used to maintain validity of shared information using view-assembly rules and document-change policies.

FIG. 7 depicts another example technique that can be used to maintain validity of shared information using blank placeholders in non-accessible document portions.

FIG. 8 depicts an example apparatus that can be used to implement the example methods described herein to maintain validity of shared information.

FIG. 9 is an example flow diagram representative of a process that may be used to assemble different views for different clients based on access control permissions and the view-assembly rules of FIG. 6.

FIG. 10 is an example flow diagram representative of a process that may be used to selectively allow document changes based on the view-assembly rules and document-change policies of FIG. 6.

FIG. 11 is an example flow diagram representative of a process that may be used to selectively allow changes to access control permissions associated with a document based on the view-assembly rules and document-change policies of FIG. 6.

FIG. 12 is an example flow diagram representative of a process that may be used to assemble different views for different clients based on access control permissions and the blank placeholders of FIG. 7.

FIG. 13 is an example flow diagram representative of a process that may be used to assemble different views for different clients selectively based on the view-assembly rules of FIG. 6 or the blank placeholders of FIG. 7.

FIG. 14 is an example processor system that can be used to implement the example methods and apparatus disclosed herein.

### DETAILED DESCRIPTION

Although the following discloses example methods and apparatus including, among other components, software executed on hardware, it should be noted that such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

The example methods and apparatus described herein can be used to maintain validity of shared information stored in a network system that is accessed by a plurality of users. The example methods and apparatus described herein can be used in connection with mobile communication devices, mobile computing devices, or any other device capable of accessing information over a wired or wireless network. Such devices, also referred to as user equipment (UE), clients, or terminals, may include mobile smart phones (e.g., a BLACKBERRY® smart phone), personal digital assistants (PDA), laptop/notebook/netbook computers, desktop computers, etc.

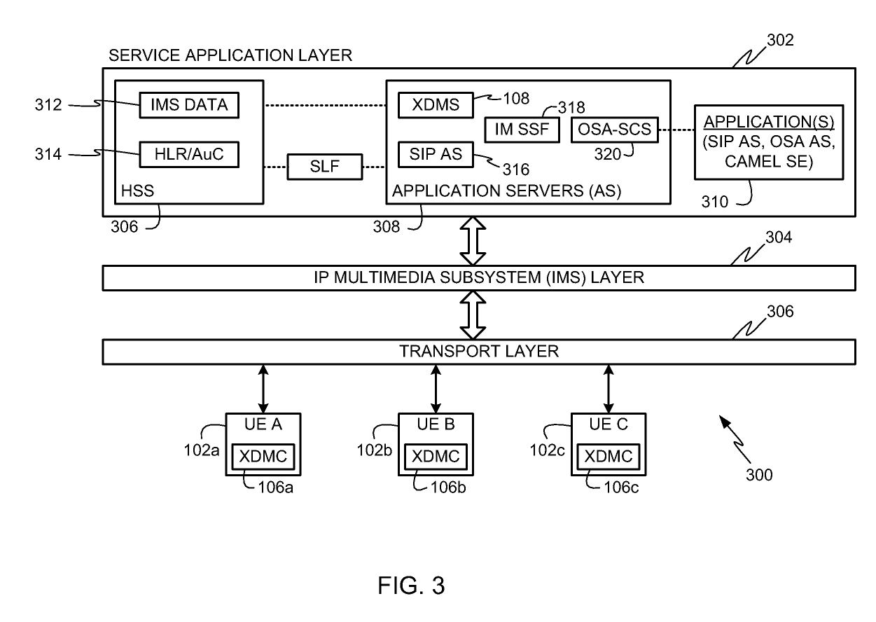

The example methods and apparatus are described herein in connection with the Open Mobile Alliance (OMA) standard related to extensible markup language (XML) document management (XDM), which, among other things, defines how to access, modify, create, etc. information in XML documents stored on network storage entities. However, the example methods and apparatus may additionally or alternatively be implemented in connection with other information management and access standards and document format standards other than the XML format. In addition although the example methods and apparatus described herein can be implemented in any network environment providing access to information stored on the network, the example methods and apparatus are described herein in connection with telecommunication network systems such as the network system 300 of FIG. 3 having an internet protocol (IP) multimedia subsystem (IMS).

The OMA XDM standard defines how to manipulate user-specific, service-related information stored in XML documents. Such information is often shared between different users and is expected to be stored in the network where it can be located, accessed and manipulated (e.g. created, changed, and deleted) by those users. The XDM standard also defines how such information is to be defined in structured XML documents and defines a common protocol to access and manipulate such XML documents, by authorized principals (i.e., users with assigned access rights). Users access documents via XDM clients (XDMCs) such as UE or terminals, and access to the documents is managed in a network by one or more XDM servers (XDMSs) based on different access permissions uniquely corresponding to respective users.

In some example implementations, example methods and apparatus implemented in accordance with the teachings described herein may involve generating a document subset corresponding to a portion of a standard-formatted document (e.g., an XML document) for a user requesting the document subset. In such example methods and apparatus, the validity of the document subset may be maintained based on assembly rules associated with the standard-formatted document and access control permissions (ACPs) associated with the user. For example, the document subset is valid when a standardized structural format (e.g., an XML structural format) associated with the standard-formatted document is not violated. In some example implementations, requests to change one or more ACPs may be evaluated and accepted or rejected based on whether such ACP change(s) would result in maintaining the validity of or render invalid one or more document subsets that may be generated based on the standard-formatted document and the requested ACP change(s). In some example implementations, a tangible machine accessible medium may be provided with instructions stored thereon that, when executed, cause a machine to implement such example methods and apparatus.

In some example implementations, example methods and apparatus implemented in accordance with the teachings described herein may involve generating a document subset corresponding to a portion of a standard-formatted document (e.g., an XML document) and identifying elements of the standard-formatted document that a schema of the standard-formatted document indicates as being required in the document subset. A first group of the elements having access permissions set to retrievable may be provided in the document subset, and placeholders may be provided in the document subset for a second group of the elements having access permissions set to not retrievable. The access permissions of the first and second group of the elements may correspond to a user requesting the document subset. The placeholders may be blank or may include values indicative of restricted access to the second group of elements. In some example implementations, the document subset may be sent to a mobile communication device. In some example implementations, a tangible machine accessible medium may be provided with instructions stored thereon that, when executed, cause a machine to implement such example methods and apparatus.

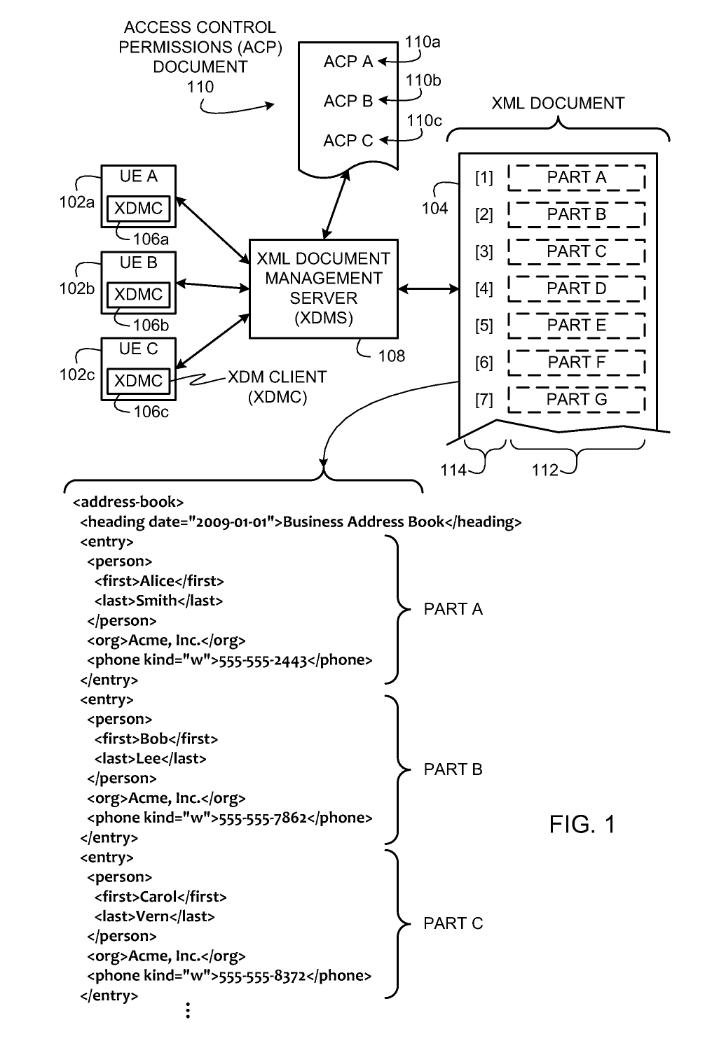

Turning to FIG. 1, example user equipment (UE) clients A-C 102a-c are shown requesting access to a shared document 104. In the illustrated example, each of the UE A-C clients 102a-c runs a respective XDMC 106a-c that communicates with an XDMS 108 to access the shared document 104. The shared document 104 is shown as an XML document. The XDM standard can be used to manage access to XML documents belonging to authorized users based on access control permissions (ACPs). In the illustrated example of FIG. 1, an ACP document 110 is provided to specify different user access permissions for the XML document 104. The ACP document 110 is shown as having ACPs A-C 110a-c, each of which corresponds to a respective one of the XDMCs 106a-c. More specifically, the ACPs A-C 110a-c correspond to XDM authorized users or principals (discussed below) associated with the XDMCs 106a-c. In particular, the ACP A 110a corresponds to a principal corresponding to the XDMC 106a, the ACP B 110b corresponds to a principal corresponding to the XDMC 106b, and the ACP C 110c corresponds to a principal corresponding to the XDMC 106c.

Authorized XDM users are called principals, which include admin principals, primary principals, and regular principals. A primary principal is a user that owns a given document (e.g., the XML document 104) and has full access rights (e.g., read, write, delete). An admin principal is a user that is authorized to modify access permissions associated with a document and delegate rights to other principals. Documents have a primary principal and an admin principal that may be assigned, for example, at document creation time. In some instances, the primary principal and the admin principal can be the same user. A regular principal is a user that is assigned some access permissions associated with a document.

In the illustrated example of FIG. 1, the XML document 104 includes different parts A-G, which can be XML elements or attributes, and each of the parts A-G 112 is shown in association with a respective index number [1]-[7] 114. Each of the XDMCs 106a-c is associated with a respective principal. The XML document 104 is administered and managed by an admin principal that creates different access permissions stored in the ACPs A-C 110a-c to define which of the parts A-G 112 are accessible by respective principals associated with the XDMCs 106a-c. For example, a principal corresponding to the XDMC 106a may be granted permissions to access (e.g., retrieve, modify, etc.) certain portions (e.g., elements or attributes) of the XML document 104 that are different from other portions accessible by a principal corresponding to the XDMC 106c.

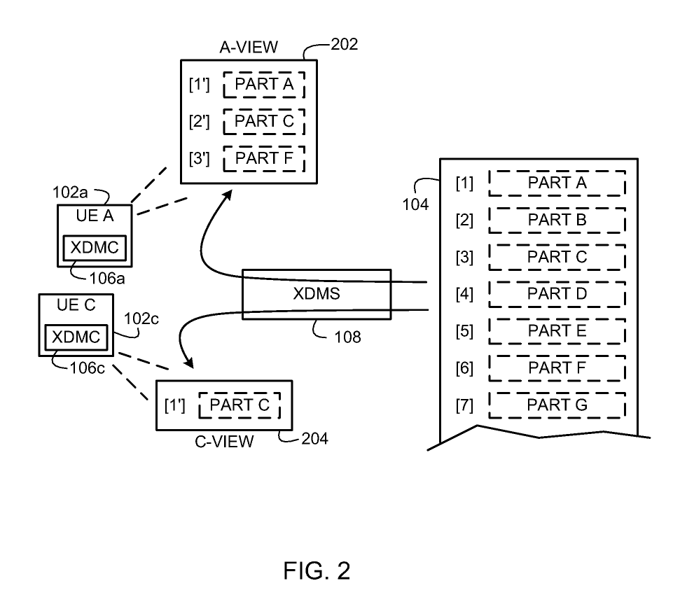

Turning to FIG. 2, the UE A and C clients 102a and 102c are shown accessing respective views 202 and 204 of the shared document 104. In the illustrated examples described herein, client views such as the views 202 and 204 may also be referred to as subsets or document subsets that, as discussed below, include at least a subset of information in a document such as the shared document 104. When the UE A 102a submits a request via the XDMC 106a to access information in the XML document 104, the XDMS 108 receives and handles the request by confirming the access permissions associated with the requesting client, XDMC 106a, and returns the assembled subset or view 202 of the document showing only the elements or attributes of the document for which the XDMC 106a is assigned access permissions.

Using known techniques for assembling different views (e.g., the views 202 and 204) for respective clients based on access permissions can often result in views that are not valid XML documents. For example, if access permissions define that a parent element is not visible and a child element is visible, the child element will be included in a view without the context of the enclosing parent element. Or, if an XML schema specifies a minimum occurrence (minOccurs) of particular elements to be greater than zero and applying an access permission would result in none of the elements or attributes being visible, an invalid XML document would be generated. Further problems associated with generating views or subsets of an XML document can result when a principal changes a server document in such a way that it differs from an already generated client views residing on one or more other clients and the clients whose views differ need to be notified about the change. This problem may arise when the principal changes the contents of the document or restricts access permissions associated with certain document parts that are already pending in document views residing on other clients.

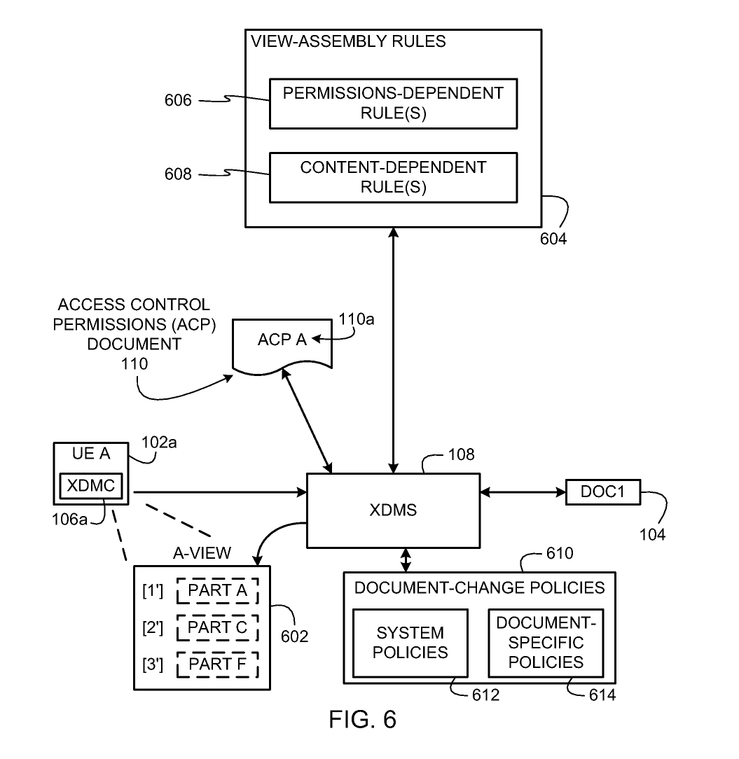

The example methods and apparatus described herein can be used to overcome the above-described problems and other problems associated with information integrity to enable maintaining the validity of information stored on a network. In some example implementations as discussed in greater detail below in connection with FIG. 6, data access rules are used by XDMSs to create valid XML document views or XML document subsets for requesting XDMCs. The rules can be pre-defined to ensure that any subset or view of an XML document is generated only if it results in a valid subset or view regardless of the particular schema defined for that XML document.

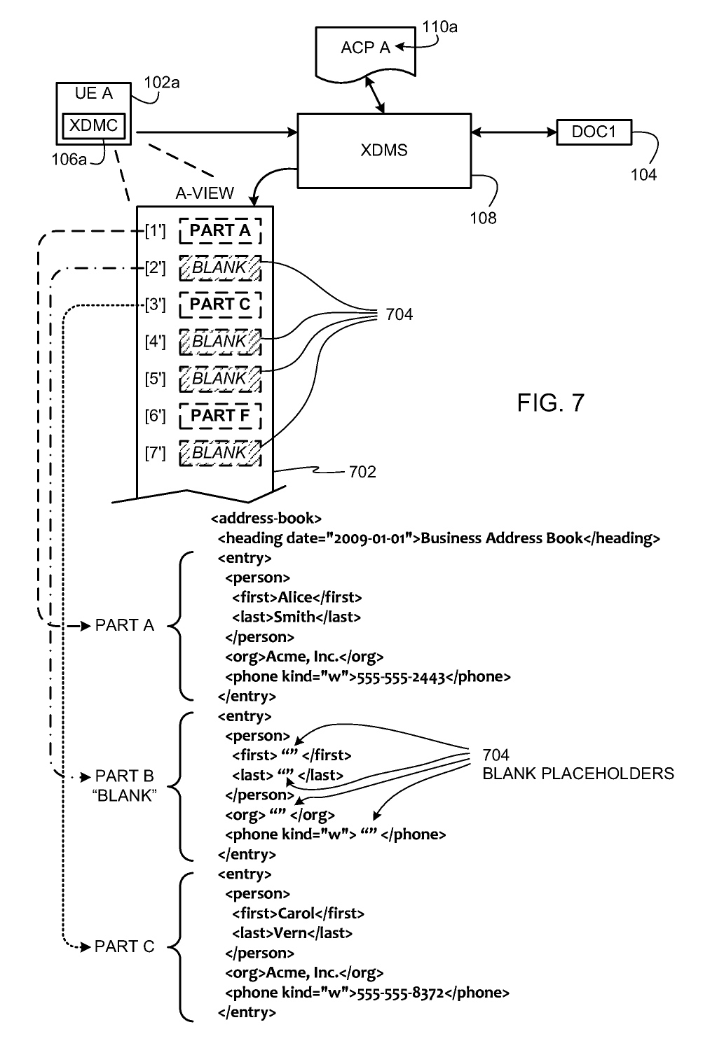

In other example implementations as discussed in greater detail below in connection with FIG. 7, XDMSs can be configured to use blank placeholders to replace elements or attributes while generating a subset or view for a requesting XDMC when the access permissions corresponding to the requesting XDMC do not allow access to those elements or attributes. In this manner, the structure of an XML document as defined by a corresponding XML schema would remain the same and valid through the use of the blank place holders.

Turning now to FIG. 3, the methods and apparatus described herein can be implemented in a communication network 300 implemented using an IP multimedia subsystem (IMS) as shown in FIG. 3. The example network 300 is shown as having a service application layer 302, an IMS layer 304, and a transport layer 306. In the illustrated example, the XDMS 108 of FIGS. 1 and 2 is implemented in the service application layer 302, and the XDMCs 106a-c communicate with the XDMS 108 via the transport layer 306. Although the methods and apparatus are described in connection with the network 300, the methods and apparatus can be implemented in various networks.

Turning in detail to the service application layer 302, in the illustrated example the service application layer 302 includes a home subscriber server (HSS) 306, application servers 308, and one or more applications 310. The HSS 306 stores subscriber profiles (e.g., IMS data 312) and performs authentication and authorization processes (e.g., via a home location register/authentication center (HLR/AuC) 314) to determine communication services and features that users are authorized to access or use. The application servers 308 host and execute services and communicate with the IMS layer 304 using session initiation protocol (SIP). In the illustrated example, the application servers 308 include the XDMS 108, a SIP AS 316, an IP multimedia service switching function (IM SSF) 318, and an open service access-service capability server (OSA-SCS) 320.

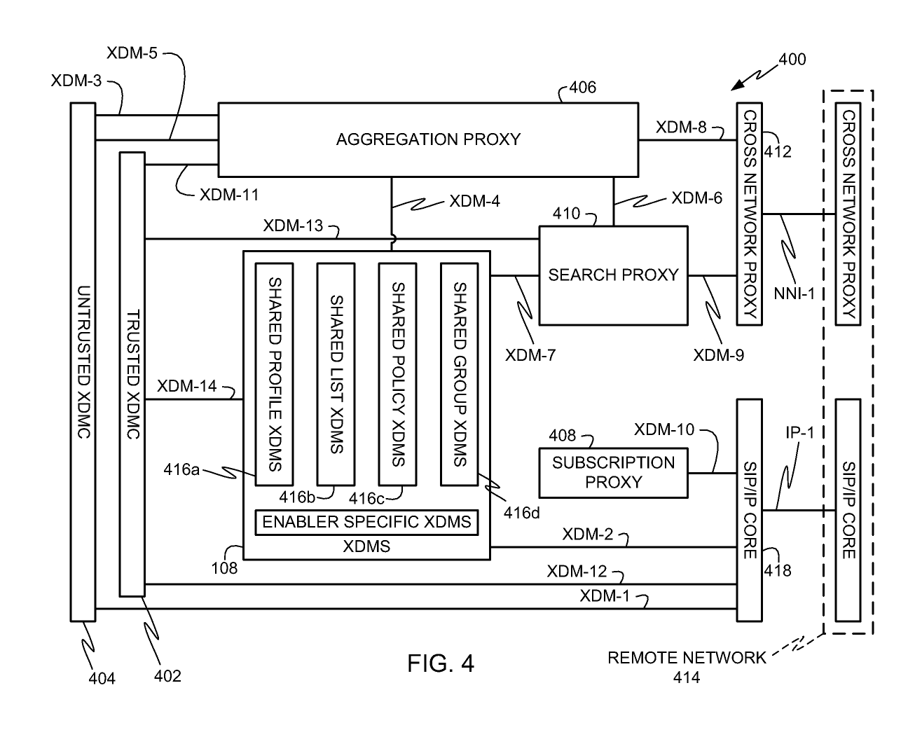

In the illustrated example, each of the XDMCs 106a-c initializes communications with the service application layer 302 through a SIP registration process that occurs via the IMS layer 304. After the SIP registration process, the XDMCs 106a-c can communicate with the XDMS 108 via the hypertext transfer protocol (HTTP) to perform document management functions. For example, the XDMCs 106a-c can submit information requests to the XDMS 108 using HTTP messages, and the requests and requested document information can be exchanged between the XDMCs 106a-c and the XDMS 108 via different proxies as described below in connection with FIG. 4.

FIG. 4 depicts an example XDM system 400 to enable the XDMCs 106a-c of FIGS. 1-3 to access shared information (e.g., the XML document 104 of FIGS. 1 and 2) stored in the network 300 of FIG. 3. The example XDM system 400 includes a plurality of different proxy interfaces (interfaces XDM-1 through XDM-14 as shown) that exchange communications with the XDMS 108 to provide the XDMCs 106a-c with access to shared information (e.g., the XML document 104 of FIGS. 1 and 2). The interfaces XDM-1 through XDM-14 are described in greater detail below.

In the illustrated example, the XDM system 400 includes the XDMS 108 in communication with a trusted XDMC 402 and an untrusted XDMC 404. The trusted XDMC 402 or the untrusted XDMC 404 can be any of the XDMCs 106a-c of FIGS. 1-3. To enable communication with the XDMS 108, the XDM system 400 includes an aggregation proxy 406, a subscription proxy 408, a search proxy 410, and a cross-network proxy 412, all of which can be implemented using one or more different entities of the network 300 of FIG. 3. In the illustrated example, the aggregation proxy 406 performs authentication of XDMCs. In addition, the aggregation proxy 406 routes information requests to the XDMS 108 and search requests to the search proxy 410. Information requests can be made using an XML configuration access protocol (XCAP) defined in IETF-RFC 4825. In the illustrated example, the aggregation proxy 406 is a single point of contact for untrusted XDMCs such as the untrusted XDMC 404, and enables the untrusted XDMC 404 to make requests to and receive information from the XDMS 108.

The subscription proxy 408 is configured to provide notifications to XDMCs (e.g., the XDMCs 106a-c of FIGS. 1-3 and the XDMCs 402 and 404) of any changes to documents managed by the XDMS 108. In addition, the subscription proxy 408 also maps XCAP resources to the SIP address of the XDMS 108 to enable proper routing of XCAP messages to the XDMS 108. The search proxy 410 is provided to route and aggregate search requests and responses between XDMCs (e.g., the XDMCs 106a-c, 402, and 404), XDMSs (e.g., the XDMS 108), and the cross-network proxy 412. The cross-network proxy 412 enables XDM systems (similar to the XDM system 400) located in other networks (e.g., a remote network 414) to communicate over a trusted connection and exchange XCAP and search requests and responses with the XDM system 400.

In the illustrated example, the XDMS 108 is shown as a logical grouping or collection of a plurality of different XDMSs 416a-d in the XDM system 400. In particular, the XDMS 108 is shown in connection with a shared profile XDMS 416a, a shared list XDMS 416b, a shared policy XDMS 416c, and a shared group XDMS 416d, all of which are typical XDMSs in an XDM system. In addition, one or more additional enabler specific XDMSs may also be provided. Each of the XDMSs 416a-d provides XML document management services for its respective type of information. For example, the shared profile XDMS 416a manages stored user profiles. The shared list XDMS 416b manages uniform resource identifier (URI) list and group usage list documents. The shared policy XDMS 416c manages user access policies. The shared group XDMS 416d manages group documents. In other example implementations, an XDM system may be provided with fewer or more types of XDMSs.

The XDMCs 402 and 404 communicate with the XDMS 108 via the interfaces XDM-1 through XDM-14 to access documents via the XDMS 108. The interfaces XDM-1, XDM-2, XDM-10, and XDM-12 enable SIP subscribe/notify exchanges between the XDMCs 402 and 404, a SIP/IP core 418, the XDMS 108, and the subscription proxy 408 to register the XDMCs 402 and 404 with the XDM system 400. The interfaces XDM-3 and XDM-4 enable exchanges associated with document management requests/responses and confirmations of access permissions (e.g., access permissions associated with the ACP's A-C 110a-c). The interfaces XDM-5, XDM-6, XDM-7, and XDM-13 enable exchanges associated with search requests/responses. The interface XDM-8 enables forwarding of document management communications to other domains, and the interface XDM-9 enables forwarding of search requests/responses to other domains. The interfaces XDM-11 and XDM-14 enable communications associated with document management accesses (e.g., create, change, delete).

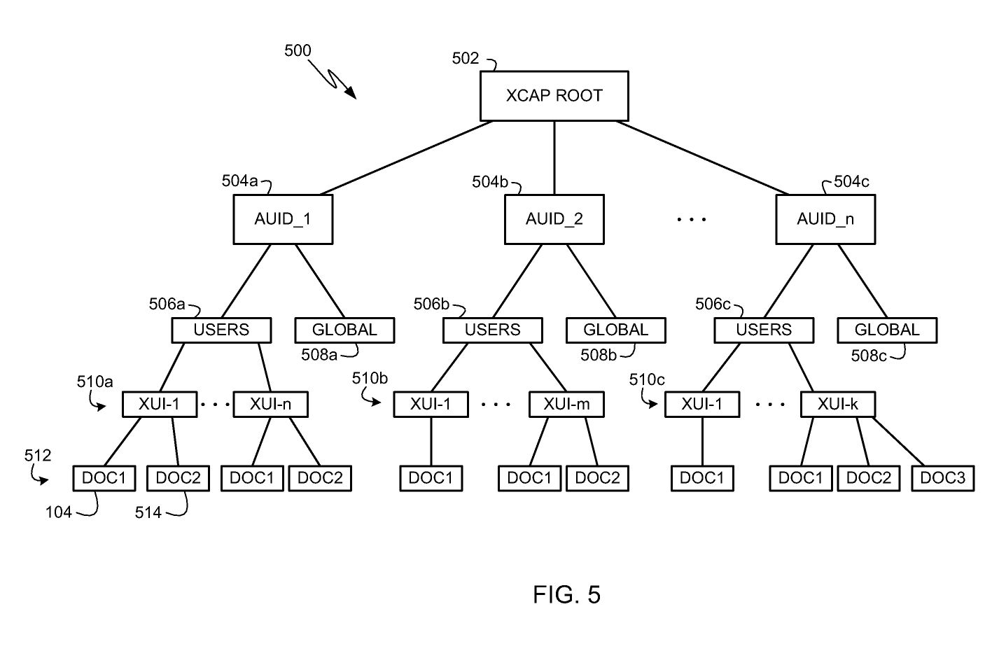

FIG. 5 depicts an example logical storage structure 500 of shared documents stored in the network 300 of FIG. 3. The XDMS 108 of FIGS. 1-4 can store documents based on the logical storage structure 500, and the documents can be associated with different application usages. For example, some documents may contain information associated with calendaring applications, while other documents may contain information associated with address books. Documents can also have other uses. For example, some uses can be application specific, while other uses are not application-specific. Example application-specific uses include storing subscriber preferences for particular service enablers (e.g., a presence subscription policy enabler or a push-to-talk over cellular (PoC) groups enabler). Example non-application-specific uses include storing a list of uniform resource identifiers (URIs) (e.g., a list of friends) that can be re-used from multiple enablers.

In some example implementations, the XDM standard can be used to implement a presence subscription policy to facilitate authorization of individuals who may wish to access another individual's presence information to determine whether that individual is presently available on a network for communication. In other example implementations, XDM can be used in a group calling application to specify a group definition to facilitate session initiation of many individuals to the same conference call. In these examples, there is common information that is shared across multiple OMA enablers. For example, a URI list defined within a presence subscription policy enabler could be used to initiate a conference call amongst an online group of friends.

As shown in FIG. 5, the logical storage structure 500 represents a flat tree hierarchy and includes an XCAP root path 502 under which application usage ID (AUID) trees 504a-c are located. Each of the AUID trees 504a-c is shown as having respective users trees 506a-c and global trees 508a-c. Each of the users trees 506a-c is shown as having specific user IDs (XUIs) 510a-c. Below each XUI are one or more documents 512. For example, the XML document 104 of FIGS. 1 and 2 is shown as stored under the XUI-1 user ID tree.

In the illustrated example, each of the AUIDs 504a-c represents a different application usage, and each of the XUIs 510a-c represents a different user or principal under which documents store information pertinent to respective ones of the AUIDs 504a-c. For example, if the AUID 504a represents an address book application usage (i.e., AUID_1=‘address-book’), the XML document 104 can store contact information for a personal address book owned by the user XUI-1 510a, while another XML document 514 can store contact information for a business address book also owned by the user XUI-1 510a. When one of the XDMCs 106a-c requests access to any of the documents 512, an XCAP request is communicated to the XDMS 108 (FIGS. 1-4) with the request defining the path in the logical storage structure 500 indicating the document sought to be accessed. For example, a path ‘http://[XCAP Root]/address-book/users/someuser/buddies/˜˜/entry[5]’ indicates the fifth ‘entry’ element in the document named ‘buddies’ (e.g., personal address book) belonging to ‘someuser’ under the ‘address-book’ application usage.

FIG. 6 depicts an example technique that can be used to maintain validity of shared information using a rules-based view-assembly process. In the illustrated example, upon receipt of an access request from the XDMC 106a, the XDMS 108 retrieves attributes or elements from the XML document 104 that the XDMC 106a is authorized to access based on the ACP A 110a (FIG. 1) and generates a view (or subset) 602. To ensure that the view 602 is a valid XML document, the XDMS 108 is provided with view-assembly rules 604. The view-assembly rules 604 are defined to ensure that the XDMS 108 extracts portions from the XML document 104 and assembles them such that valid XML views or subsets are provided (e.g., an XML view or subset is valid if it is structured in accordance with XML coding formats or standards). The view-assembly rules 604 are also defined to prevent the XDMS 108 from assembling a view (e.g., the view 602) if such a view would not be a valid XML document. For example, if the access permissions ACP A 110a indicate that the XDMC 106a can access a child element but not its corresponding parent element, the view-assembly rules 604 can be defined to prevent the XDMS 108 from generating a corresponding view for the XDMC 106a because providing the child element without the parent element would create an invalid XML view by having the child element without the context of the parent.

In the illustrated example, the view-assembly rules 604 include one or more permissions-dependent rules 606 and one or more content-dependent rules 608. The permissions-dependent rules 606 are rules based on the access permissions associated with a document. The content-dependent rules 608 are rules based on the information or content stored in a document.

The following example rules can be used as the permissions-dependent rules 606. An example permissions-dependent rule can specify that a child element cannot be retrievable if a corresponding parent element is not retrievable. Another example permissions-dependent rule can specify that if an element is retrievable, all attributes of the element in the XML schema for its corresponding document that are declared with the ‘use’ parameter equal to ‘required’ (i.e., use=required) must also be retrievable. Another example permissions-dependent rule can specify that if a parent element is modifiable then all the child elements must also be modifiable, but if the parent element is not modifiable, then some child elements may be modifiable. Another example permissions-dependent rule can specify that modify and delete rights can be assigned only together with retrieve rights (i.e., an element can be either only retrievable, both retrievable and modifiable, but not only modifiable).

An example rule that can be used as part of the content-dependent rules 608 can specify that if a retrieve restriction on children elements as defined by ACPs (e.g., the ACPs A-C 110a-c) conflicts with a minOccurs schema specification for a corresponding parent element, then the parent cannot be retrievable. In XML schema notation, the minOccurs parameter indicates that the content of an XML document must have a minimum number of child element occurrences for a particular parent. Violating the minOccurs parameter can result in an invalid XML document view or subset. For example, if a parent element <phone-number> has a minOccurs indicator of 1, and the parent element has two corresponding child elements, one of which is accessible by a user and one which is not, a view for that user will be invalid if the document owner removes the child element that is accessible by the user. That is, when the document owner removes the accessible child element, only the child element that is not accessible to the user will remain such that any subsequent view or subset assembled for that user will contain zero child elements for the <phone-number> parent element. The resulting view or subset will be in violation of the corresponding minOccurs indicator that is set to 1. Thus, a content-dependent rule that will prevent generation of views that would violate a minOccurs schema specification can be used to avoid generating this type of invalid XML view. Other types of content-dependent rules can similarly be implemented.

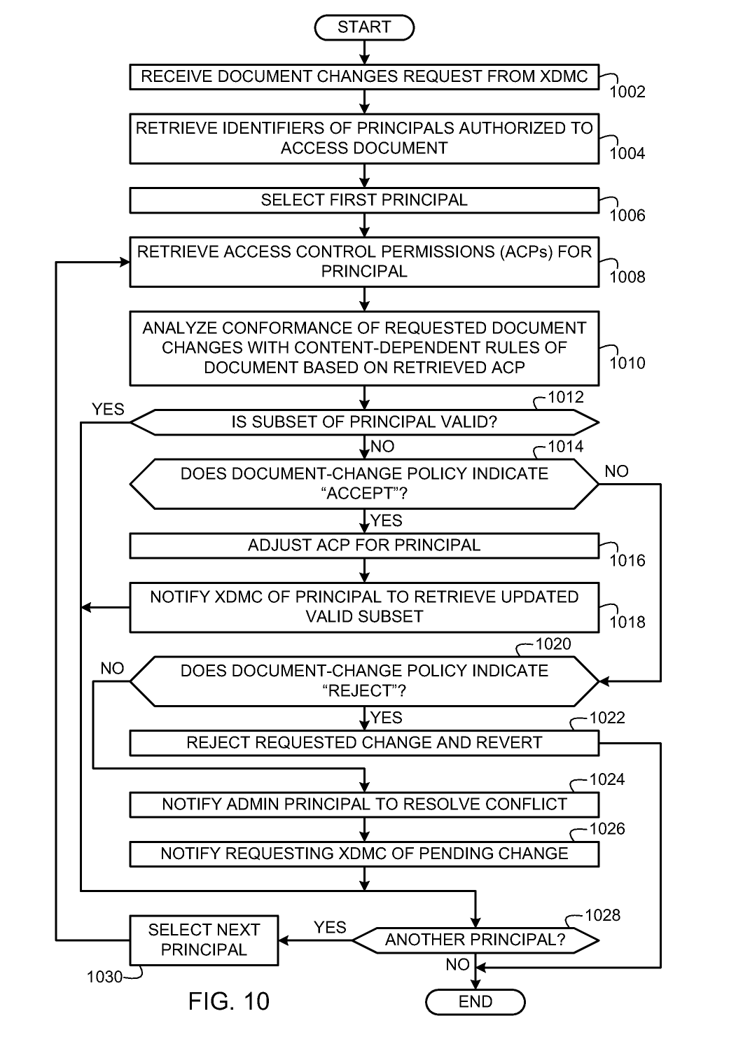

A view or subset of a document derived by applying ACPs (e.g., the ACPs A-C 110a-c of FIG. 1) can become invalid either after document content is modified or after ACPs are modified. In the illustrated example, the XDMS 108 is configured to re-evaluate the content-dependent rules 608 after a document content update based on the modified content to ensure that any existing assembled views or subsets (e.g., the view 602) are still valid. An example process that may be used to re-evaluate the content-dependent rules 608 after a document content update is described below in connection with FIG. 10. Such re-evaluations based on the above-described example rules may indicate when document content changes should be rejected or should be accepted.

A request to update the content of a document may be rejected when an access permission of a parent element is set to retrievable prior to receiving the requested document change, a minimum occurrences (minOccurs) requirement of the parent element defines a number of child elements that must be retrievable when the parent element is retrievable and the requested document content change results in a number of retrievable child elements not satisfying the minimum occurrences requirement of the parent element. However, the request to update the content of the document may be accepted if, in response to accepting the request, the access permission of the parent element is changed to not retrievable when the content of the standard-formatted document is updated.

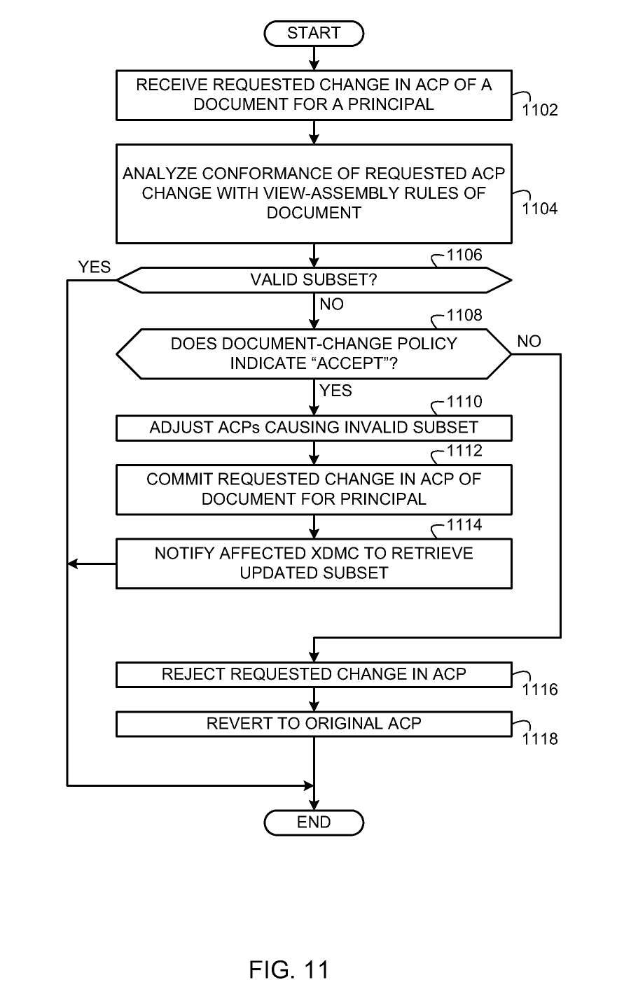

In addition, the XDMS 108 is also configured to re-evaluate the permissions-dependent rules 606 and the content-dependent rules 608 after a change in ACPs to ensure that any existing assembled views or subsets (e.g., the view 602) are still valid. An example process that may be used to re-evaluate the permissions-dependent rules 606 and the content-dependent rules 608 after a requested change in ACPs is discussed below in connection with FIG. 11. Such re-evaluations based on the above-described example rules may indicate when ACP changes should be rejected or should be accepted.

A request to update an ACP may be rejected when an access permission of a parent element is set to not retrievable prior to receiving the requested ACP change and the requested ACP change involves changing an access permission of a child element corresponding to the parent element to retrievable. However, the requested ACP change may be accepted under such circumstances when, in response to accepting the requested ACP change, the access permission of the child element is changed to retrievable and the access permission of the parent element is changed to retrievable.

A request to update an ACP may be rejected when an access permission of a child element is set to retrievable prior to receiving a requested ACP change and the requested ACP change involves changing an access permission of a parent element corresponding to the child element to not retrievable. However, the requested ACP change may be accepted under such circumstances when, in response to accepting the requested ACP change, the access permission of the parent element is changed to not retrievable and the access permission of the child element is changed to not retrievable.

A request to update an ACP may be rejected when an access permission of an element is set to retrievable prior to receiving the requested ACP change, a schema of the standard-formatted document declares an attribute of the element as required when the element is retrievable, and the requested ACP change involves changing an access permission of the attribute to not retrievable. However, the requested ACP change may be accepted under such circumstances when, in response to accepting the requested ACP change, the access permission of the attribute is changed to not retrievable and the access permission of the element is changed to not retrievable

A request to update an ACP may be rejected when an access permission of an attribute is set to not retrievable prior to receiving the requested ACP change, a schema of the standard-formatted document declares the attribute as required when a corresponding element is retrievable, and the requested ACP change involves changing an access permission of the element corresponding to the attribute to retrievable. However, the requested ACP change may be accepted under such circumstances when, in response to accepting the requested ACP change, the access permission of the element is changed to retrievable and the access permission of the attribute is changed to retrievable.

A request to update an ACP may be rejected when an access permission of a parent element is modifiable prior to receiving the requested ACP change and the requested ACP change involves changing an access permission of a child element corresponding to the parent element to not modifiable. However, the requested ACP change may be accepted under such circumstances when, in response to accepting the requested ACP change, changing the access permission of the child element to not modifiable and the access permission of the parent element to not modifiable.

A request to update an ACP may be rejected when an access permission of an element is set to not retrievable prior to receiving the requested ACP change and the requested ACP change involves changing the access permission of the element to modifiable while also being not retrievable. However, the requested ACP change may be accepted under such circumstances when, in response to accepting the requested ACP change, the access permission of the element is changed so that it is modifiable and retrievable.

A request to update an ACP may be rejected when an access permission of an element is set to retrievable and modifiable prior to receiving the requested ACP change and the requested ACP change involves changing the access permission of the element to not retrievable while also being modifiable. However, the requested ACP change may be accepted under such circumstances when, in response to accepting the requested ACP change, the access permission of the element is changed so that it is not retrievable and not modifiable.

A request to update an ACP may be rejected when an access permission of a parent element is set to retrievable prior to receiving the requested ACP change, a minimum occurrences (minOccurs) requirement of a parent element defines a number of child elements that must be retrievable when the parent element is retrievable, and the requested ACP change involves changing an access permission of at least one child element to not retrievable resulting in the number of child elements set to retrievable not satisfying the minimum occurrences requirement of the parent element. However, the requested ACP change may be accepted under such circumstances when, in response to accepting the requested ACP change, the access permission of the at least one child element is changed to not retrievable and the access permission of the parent element is changed to not retrievable.

When a document update renders a view or subset for one or more principals that is invalid, notifications can be sent to those one or more principals. In the illustrated example, the principal performing the update is notified of the invalidity. For example, upon notification the principal that requested the modification may choose not to perform the update. However, if the update is committed, then any principal whose view is affected is notified to update their views. In addition, the admin principal that administers the affected document is notified. In this manner, the admin principal can decide whether to modify the ACPs associated with the affected document to rectify the situation.

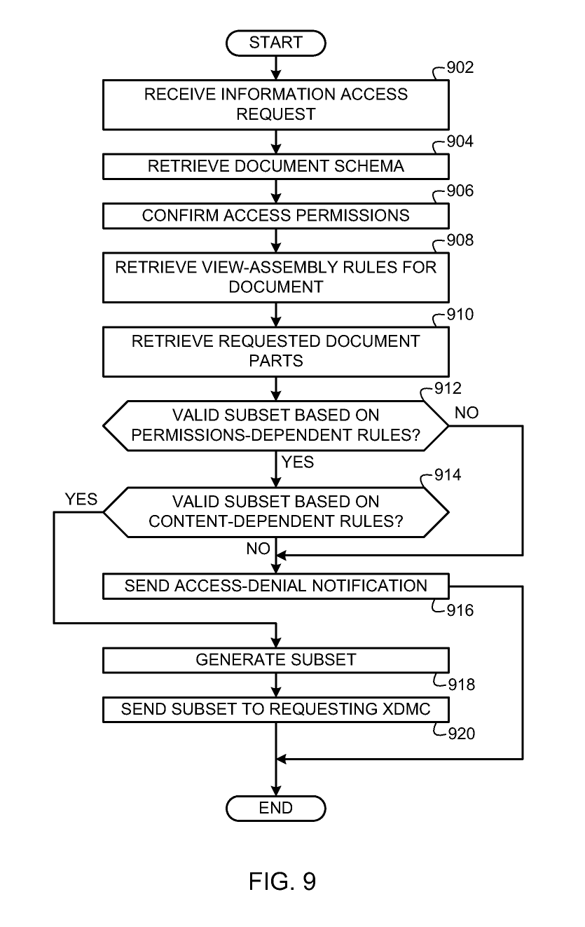

An example manner of automating actions taken by principals affected by document changes is through the use of document-change policies 610. A policy can be implemented as a system-wide policy or a per-document policy. In the illustrated example, the document-change policies 610 include system policies 612 for system-wide policies that are generally applicable to all documents managed by a particular XDMS (e.g., the XDMS 108) and document-specific policies 614 for document-specific policies that are specifically applicable to particular respective documents (e.g., the XML document 104). In some example implementations, a system-wide policy can be used by default but be overridden under defined conditions by an overriding per-document policy. An example policy may be to unconditionally accept changes to documents and notify the affected principals. Another example policy may be to reject changes and notify the principal that attempted the update. Yet another example policy may be to queue up a change until the admin principal resolves any issues, and while the change is queued up notify the principal that attempted the update that the update is still pending. Example processes of applying the view-assembly rules 604 and the document-change policies 610 of FIG. 6 are described below in connection with the example flow diagrams of FIGS. 9-11.

FIG. 7 depicts another example technique that can be used to maintain validity of shared information by using blank placeholders in assembled views or subsets to take the place of document portions that requesting users are not authorized to access. In the illustrated example, upon receipt of an access request from the XDMC 106a, the XDMS 108 retrieves attributes or elements (e.g., a group of attributes or elements) from the XML document 104 that the XDMC 106a is authorized to access based on the ACP A 110a (FIG. 1) and generates a view (or subset) 702. To ensure that the view 702 is a valid XML document, the XDMS 108 inserts blank placeholders 704 for any attribute or element (e.g., a group of attributes or elements) that the XDMC 106a is not authorized to access. As shown in FIG. 7, the XDMC 106a is authorized to access PART A [1′], PART C [3′], and PART F [6′] of the XML document 104, but it is not authorized to access PART B [2′], PART D [4′], PART E [5′], and PART G [7′]. The blank placeholders 704 are shown by way of example in FIG. 7 as empty elements in PART B of the view 702 (i.e., <first>“”</first>, <last>“”</last>, etc.).

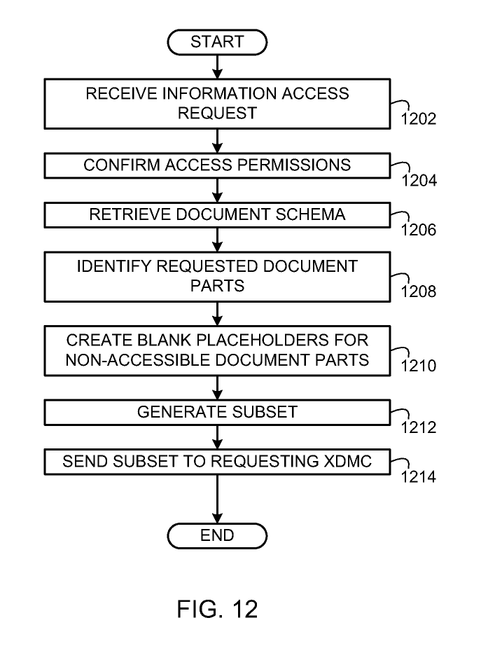

The XDMS 108 can use the blank placeholders 704 to ensure that it assembles views or subsets that are valid XML documents. By using the blank placeholders 704, the XDMS 108 can generate views that do not violate XML schema specifications such as the minOccurs specification because the blank placeholders 704 ensure that a generated view retains the structure specified in a corresponding XML schema. Although the blank placeholders 704 appear as blank (i.e., no information) in the illustrated example of FIG. 7, in other example implementations, the blank placeholders 704 may be provided with pre-defined values (e.g., restrict codes) indicating a restriction or restricted access to the information in the elements corresponding to the blank placeholders 704. An example process of using the blank placeholders 704 is described below in connection with the example flow diagram of FIG. 12.

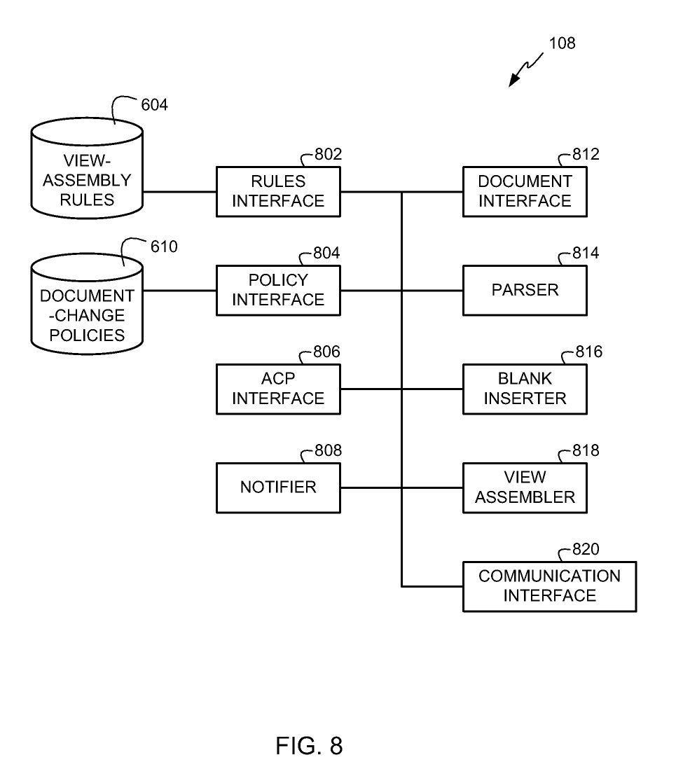

FIG. 8 depicts an example apparatus that can be used to implement the example XDMS 108 (FIGS. 1-4, 6, and 7) to maintain validity of shared information (e.g., the XML document 104 of FIGS. 1-3, 5, 6, and 7). In the illustrated example, the example XDMS 108 includes a rules interface 802, a policy interface 804, an ACP interface 806, a notifier 808, a document interface 812, a parser 814, a blank inserter 816, a view assembler 818, and a communication interface 820. The example XDMS 108 may be implemented using any desired combination of hardware, firmware, and/or software. For example, one or more integrated circuits, discrete semiconductor components, and/or passive electronic components may be used. Thus, for example, any of the rules interface 802, the policy interface 804, the ACP interface 806, the notifier 808, the document interface 812, the parser 814, the blank inserter 816, the view assembler 818, and/or the communication interface 820, or parts thereof, could be implemented using one or more circuit(s), programmable processor(s), application specific integrated circuit(s) (ASIC(s)), programmable logic device(s) (PLD(s)), field programmable logic device(s) (FPLD(s)), etc.

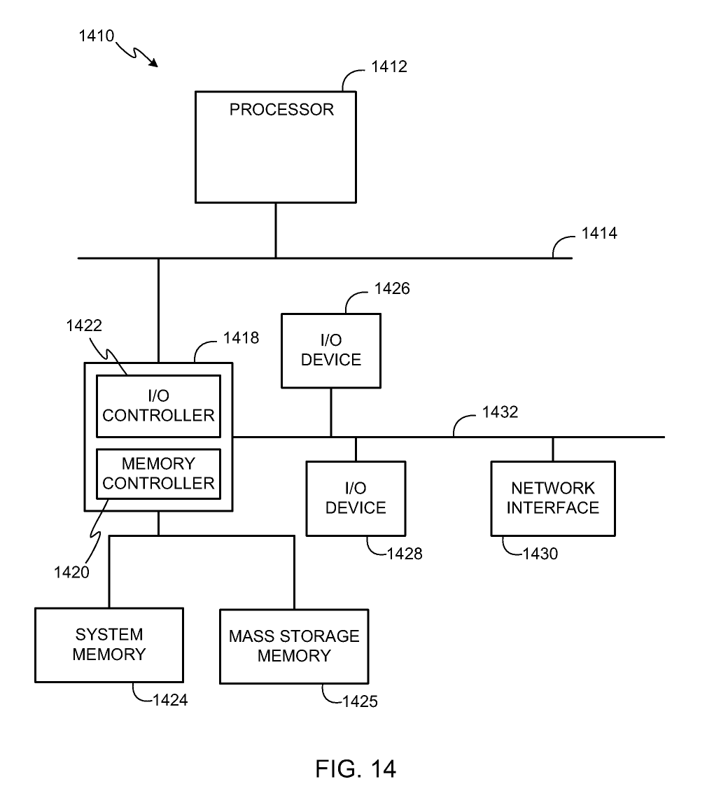

Some or all of the rules interface 802, the policy interface 804, the ACP interface 806, the notifier 808, the document interface 812, the parser 814, the blank inserter 816, the view assembler 818, and/or the communication interface 820, or parts thereof, may be implemented using instructions, code, and/or other software and/or firmware, etc. stored on a machine accessible medium and executable by, for example, a processor system (e.g., the example processor system 1410 of FIG. 14). In some implementations, at least one of the rules interface 802, the policy interface 804, the ACP interface 806, the notifier 808, the document interface 812, the parser 814, the blank inserter 816, the view assembler 818, and/or the communication interface 820 may be configured to include or otherwise use a tangible medium such as a memory, DVD, CD, etc.

Now turning in detail to FIG. 8, to access the view-assembly rules, the XDMS 108 is provided with the rules interface 802. To access the document-change policies 610, the XDMS 108 is provided with the policy interface 804. To access ACPs (e.g., the ACPs A-C 110a-c of FIG. 1), the XDMS 108 is provided with the ACP interface 806. To generate and forward notifications to users or principals informing of document changes that would affect views or subsets (e.g., the view 602 of FIG. 6) of those principals or of documents owned by those principals, the XDMS 108 is provided with the notifier 808. To create, retrieve, and/or modify documents (e.g., the XML document 104 of FIGS. 1-3 and 5-7), the XDMS 108 is provided with the document interface 812.

To retrieve parts (e.g., elements or attributes) from a document, the XDMS 108 is provided with the parser 814. For example, the parser 814 can retrieve parts for which an XDMC requesting access is authorized to access based on a corresponding ACP (e.g., the ACPs A-B 110a-c of FIG. 1). The retrieved parts can then be used to assemble a view or subset (e.g., the views 602 of FIGS. 6 and 702 of FIG. 7) for the requesting XDMC. To insert blank placeholders (e.g., the blank placeholders 704 of FIG. 7) in views or subsets (e.g., the view 702 of FIG. 7) as discussed above in connection with FIG. 7, the XDMS 108 is provided with a blank inserter 816.

To assemble views or subsets (e.g., the views 602 of FIGS. 6 and 702 of FIG. 7) of documents (e.g., the XML document 104), the XDMS 108 is provided with the view assembler 818. For example, when the XDMC 106a submits an information access request to view one or more parts of the XML document 104, the view assembler 818 can assemble the view 602 corresponding to the XDMC 106a based on the access permissions in the ACP A 110a corresponding to the XDMC 106a and also based on ones of the view-assembly rules 604 associated with the XML document 104.

To communicate with XDMCs or other XDMSs, the XDMS 108 is provided with a communication interface 820. For example, the XDMS 108 can receive information request messages and document change requests from XDMCs via the communication interface 820. In addition, the XDMS 108 can communicate responses or notifications to XDMCs via the communication interface 820.

FIGS. 9-13 depict example flow diagrams representative of processes that may be implemented using, for example, computer readable instructions that may be used to maintain validity of shared information. The example processes of FIGS. 9-13 may be performed using a processor, a controller and/or any other suitable processing device. For example, the example processes of FIGS. 9-13 may be implemented using coded instructions stored on a tangible medium such as a flash memory, a read-only memory (ROM) and/or a random-access memory (RAM) associated with a processor (e.g., the processor 1412 of FIG. 14). Alternatively, some or all of the example processes of FIGS. 9-13 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 9-13 may be implemented manually or as any combination(s) of any of the foregoing techniques, for example, any combination of firmware, software, discrete logic and/or hardware. Further, although the example processes of FIGS. 9-13 are described with reference to the flow diagrams of FIGS. 9-13, other methods of implementing the processes of FIGS. 9-13 may be employed. For example, the order of execution of the blocks may be changed, and/or some of the blocks described may be changed, eliminated, sub-divided, or combined. Additionally, any or all of the example processes of FIGS. 9-13 may be performed sequentially and/or in parallel by, for example, separate processing threads, processors, devices, discrete logic, circuits, etc.

The example processes of FIGS. 9-13 are described as executed by the XDMS 108 of FIGS. 1-4 and 6-8. As discussed above in connection with FIG. 4, the XDMS 108 can be a collection of different XDMSs, each of which manages documents associated with a respective type of information (e.g., the shared profile XDMS 416a, the shared list XDMS 416b, the shared policy XDMS 416c, and the shared group XDMS 416d). Alternatively, the XDMS 108 can be a single type of XDMS that manages a single type of document (e.g., the XDMS 108 could implement the shared profile XDMS 416a, alone). In any case, although the example processes of FIGS. 9-13 are described below in connection with the XDMS 108, other XDMSs can be adapted to similarly execute the example processes.

FIG. 9 is an example flow diagram representative of a process that may be used to assemble different views or subsets for different XDMCs (e.g., the XDMCs 106a-c of FIGS. 1-3) based on ACPs (e.g., the ACPs 110a-c of FIG. 1) and the view-assembly rules 604 of FIG. 6. Initially, the communication interface 820 (FIG. 8) receives an information access request (block 902) from an XDMC (e.g., the XDMC 106a of FIG. 6). In the illustrated example, the information access request is a request to view a particular document such as the XML document 104 of FIGS. 1, 2, 5, and 6. The document interface 812 (FIG. 8) retrieves the document schema (e.g., an XML schema) for the XML document 104 (block 904), and the ACP interface 806 confirms the access permissions (e.g., the ACP A 110a of FIG. 1) associated with the document 104 for the XDMC 106a (block 906). For example, the access permissions defined in the ACP A 110a indicate the information that the principal associated with the XDMC 106a can access in the particular XML document 104.

The rules interface 802 (FIG. 8) retrieves the view-assembly rules 604 (FIGS. 6 and 8) corresponding to the document 104 (block 908), and the parser 814 (FIG. 8) retrieves the requested document parts (block 910) from the document 104. The rules interface 802 then determines whether the view or subset to be generated based on the retrieved document parts would be valid based on the permissions-dependent rules 606 (FIG. 6) (block 912). If the view or subset would be valid based on the permissions-dependent rules 606, the rules interface 802 determines whether the view would be valid based on the content-dependent rules 608 (FIG. 6) (block 914). If the view or subset would not be valid based on the content-dependent rules 608 (block 914) or based on the permissions-dependent rules 606 (block 912), the notifier 808 (FIG. 8) generates and sends an access-denial notification to the requesting XDMC 106a (block 916).

If at block 914, the rules interface 802 determines that the view would be valid based on the content-dependent rules 608, the view assembler 818 (FIG. 8) generates the view or subset (e.g., the view 602 of FIG. 6) (block 918) based on the parts retrieved by the parser 814 at block 910. The communication interface 820 then sends the view or subset to the requesting XDMC 106a (block 920). After the communication interface 820 sends the view or subset at block 920 or after the access-denial notification is sent at block 916, the example process of FIG. 9 is ended.

FIG. 10 is another example flow diagram representative of a process that may be used to selectively allow document changes based on the view-assembly rules 604 and the document-change policies 610 of FIGS. 6 and 8. Initially, the communication interface 820 (FIG. 8) receives a document changes request from an XDMC (e.g., any of the XDMCs 106a-c of FIGS. 1-3 and 6) (block 1002). In the illustrated example, the change request corresponds to changes in the XML document 104. For example, the document changes request may contain new or updated information that an XDMC is requesting to commit or update in the XML document 104.

The ACP interface 806 (FIG. 8) retrieves identifiers of principals authorized to access the document 104 (block 1004). For example, the ACP interface 806 can retrieve the identifiers of the authorized principals from the ACP document 110 of FIG. 1. The ACP interface 806 selects a first retrieved principal identifier (block 1006) and the ACPs (e.g., the ACP A 110a of FIG. 1) for that principal (block 1008). The rules interface 802 then analyzes the conformance of the requested document changes (received at block 1002) with the content-dependent rules 608 (FIG. 6) based on the retrieved ACPs (block 1010). For example, the rules interface 802 determines whether the requested document changes would violate any of the content-dependent rules 608 of the view for the selected principal based on the portions of the XML document 104 that the principal can retrieve as defined in the ACP A 110a for that principal.

If the rules interface 802 determines that the view or subset for the selected principal would not be valid (block 1012), the policy interface 804 (FIG. 8) determines whether the document-change policies 610 (FIGS. 6 and 8) for the XML document 104 indicate that the document changes (received at block 1002) should be accepted (block 1014) even though an invalid view would result. If the document changes should be accepted (block 1014), the ACP interface 806 adjusts the ACP A 110a corresponding to the selected principal (block 1016). That is, the ACP interface 806 changes the permissions in the ACP A 110a to enable generation of a valid view after the document changes are committed. The notifier 808 (FIG. 8) then notifies the XDMC 106a of the selected principal (i.e., the principal selected at block 1006) to retrieve an updated valid view or subset (block 1018).

Returning to block 1014, if the document-change policies 610 do not indicate that the document changes should be accepted, the policy interface 804 determines whether the document-change policies 610 indicate that the document changes should be rejected (block 1020). If the document changes should be rejected (block 1020), the notifier 808 rejects the requested change (e.g., by notifying the XDMC requesting the change) and the document 104 is reverted (block 1022) with no changes being committed. However, if at block 1020 the document-change policies 610 indicate that the document changes should not be rejected, the notifier 808 notifies the admin principal of the XML document 104 to resolve the conflict (block 1024). In addition, the notifier 808 notifies the XDMC requesting the change that the change is pending (block 1026). In the illustrated example, the requested change will remain pending until the admin principal resolves the conflict or until a predetermined duration has lapsed, at which point the requested change will be automatically rejected.

After the XDMC requesting the change is notified that the change is pending (block 1026) or after notifying the XDMC to retrieve an updated valid view (block 1018) or if the view of the selected principal is valid (block 1012), the ACP interface 806 determines whether there is another principal authorized to access the XML document 104 (block 1028). If there is another principal, the ACP interface 806 selects the next principal (block 1030) for which to analyze the validity of a corresponding view and control returns to block 1008. On the other hand, if there are no more principals remaining for which to analyze validities of views (block 1028) or after the change is rejected (block 1022), the example process of FIG. 10 is ended.

FIG. 11 is another example flow diagram representative of a process that may be used to allow changes to access control permissions (e.g., the ACPs 110a-c of FIG. 1) associated with a document (e.g., the XML document 104 of FIGS. 1, 2, 5, and 6) based on the view-assembly rules 604 (FIGS. 6 and 8) and the document-change policies 610 (FIGS. 6 and 8). Initially, the ACP interface 806 (FIG. 8) receives a change in a principal's access control permissions (e.g., the ACP A 110a of FIG. 1) for a document (e.g., the XML document 104) (block 1102). For example, the ACP change may be made by the admin principal of the XML document 104 to change access permissions for the principal corresponding to the XDMC 106a (FIGS. 1-3 and 6). In response to receiving the change, the rules interface 802 analyzes the conformance of the requested ACP change with the view-assembly rules 604 of the document 104 (block 1104) and determines whether a valid view or subset can be generated based on the ACP change and the view-assembly rules 604 (block 1106). If a valid view or subset cannot be generated (block 1106), the policy interface 804 (FIG. 8) determines whether the document-change policies 610 (FIGS. 6 and 8) for the XML document 104 indicate that the ACP changes (received at block 1102) should be accepted (block 1108) even though an invalid view would result.

If the ACP change should be accepted (block 1108), the ACP interface 806 adjusts one or more permissions causing the invalid view or subset (block 1110). For example, if the requested ACP change includes various changes corresponding to different portions of a document (e.g., the XML document 104) and only one of those changes would create an invalid view or subset, the ACP interface 806 can commit all of the requested ACP changes but adjust the ACP change that would create the invalid view or subset so that a valid view or subset can be generated. The ACP interface 806 commits the change to the principal's ACP for the document 104 (block 1112). In addition, the notifier 808 (FIG. 8) notifies the affected XDMC (e.g., the XDMC 106a of FIGS. 1-3 and 6) to retrieve the new view or subset resulting from the updated ACPs (e.g., the ACP A 110a of FIG. 1) (block 1114).

Returning to block 1108, if the ACP change should not be accepted (block 1108), control advances to block 1114 at which the ACP interface 806 rejects the ACP change (block 1116), and the ACP A 110a reverts to the original ACP without committing the changes (block 1118). After the ACP changes are reverted (block 1118) or after the affected XDMC is notified to retrieve the updated ACP (block 1114) or if at block 1106 the rules interface 802 determines that a valid view would be generated based on the requested ACP changes, the example process of FIG. 11 ends.

FIG. 12 is another example flow diagram representative of a process that may be used to assemble different views or subsets for different XDMCs based on access control permissions (e.g., the ACPs A-C 110a-c of FIG. 1) and the blank placeholders 704 of FIG. 7. Initially, the communication interface 820 (FIG. 8) receives an information access request (block 1202). In the illustrated example, the information access request is received from the XDMC 106a to access information in the XML document 104. The ACP interface 806 (FIG. 8) confirms the access control permissions (e.g., the ACP A 110a) for the requesting principal (block 1204). The document interface 812 (FIG. 8) retrieves the document schema of the XML document 104 (block 1206) and identifies the requested parts of the XML document 104 (block 1208) based on the ACP A 110a and the retrieved schema. The blank inserter 816 (FIG. 8) creates blank placeholders for the non-accessible document parts (block 1210). The view assembler 818 (FIG. 8) generates a view or subset of the XML document 104 based on the information access request (block 1212) with the blank placeholders 704 at locations of the XML document 104 not accessible by the requesting principal as shown in the view 702 of FIG. 7. The communication interface 820 sends the view or subset to the requesting XDMC 106a (block 1214), and the example process of FIG. 12 is ended.

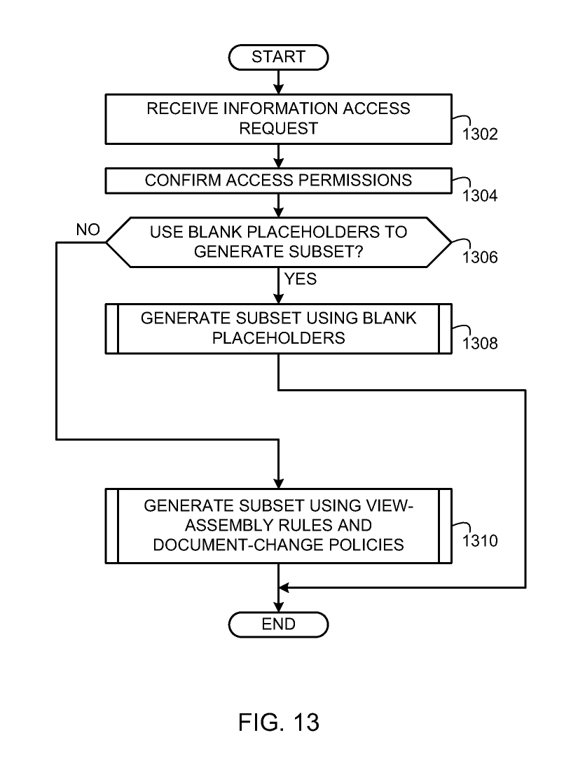

FIG. 13 is another example flow diagram representative of a process that may be used to assemble different views or subsets for different clients selectively based on the view-assembly rules 604 of FIGS. 6 and 8 and the blank placeholders 704 of FIG. 7. The example process of FIG. 13 may be used for instances in which a particular one of the view assembly techniques is more efficient than the other. For instance, for very large documents having many access restrictions, the view assembly technique based on the view-assembly rules 604 could be more efficiently used, whereas the view assembly technique based on the blank placeholders 704 would be relatively less efficient due to the need to provide a relatively large quantity of blank placeholders for the many access-restricted elements in such a large document. Alternatively, the blank placeholders 704 may be more efficiently used for smaller documents or large documents with relatively few access-restricted elements. In any case, an admin principal can indicate which view assembly technique to use for a particular document (e.g., the XML document 104) by defining a view assembly technique indicator in the ACPs (e.g., the ACPs A-C 110a-c) corresponding to that document. In this manner, when access to the document is requested, the view assembly technique to be used can be retrieved from a corresponding ACP.

Turning in detail to FIG. 13, initially, the communication interface 820 (FIG. 8) receives an information access request (block 1302). For example, the information access request can be received from the XDMC 106a to access information in the XML document 104. The ACP interface 806 (FIG. 8) confirms the access permissions of the principal associated with the XDMC 106a (block 1304) as indicated in the ACP A 110a of FIG. 1. The ACP interface 806 also determines based on the ACP A 110a whether to use the blank placeholders 704 to generate the requested view or subset (block 1306). If the ACP A 110a indicates that views should be generated using blank placeholders (block 1306), the XDMS 108 generates the requested view or subset using the blank placeholders 704 as discussed above in connection with the example process of FIG. 12 (block 1308). However, if the ACP A 110a indicates that views or subsets should be generated using the view-assembly rules 604 (block 1306), the XDMS 108 generates the requested view or subset using the view-assembly rules 604 as discussed above in connection with the example process of FIG. 9 (block 1310). The example process of FIG. 13 is then ended.

FIG. 14 is a block diagram of an example processor system 1410 that may be used to implement the example methods and apparatus described herein. For example, processor systems substantially similar or identical to the example processor system 1410 may be used to implement the rules interface 802, the policy interface 804, the ACP interface 806, the notifier 808, the document interface 812, the parser 814, the blank inserter 816, the view assembler 818, and/or the communication interface 820 of the XDMS 108 of FIGS. 1-4 and 6-8.

As shown in FIG. 14, the processor system 1410 includes a processor 1412 that is coupled to an interconnection bus 1414. The processor 1412 may be any suitable processor, processing unit, or microprocessor. Although not shown in FIG. 14, the system 1410 may be a multi-processor system and, thus, may include one or more additional processors that are identical or similar to the processor 1412 and that are communicatively coupled to the interconnection bus 1414.

The processor 1412 of FIG. 14 is coupled to a chipset 1418, which includes a memory controller 1420 and an input/output (I/O) controller 1422. A chipset provides I/O and memory management functions as well as a plurality of general purpose and/or special purpose registers, timers, etc. that are accessible or used by one or more processors coupled to the chipset 1418. The memory controller 1420 performs functions that enable the processor 1412 (or processors if there are multiple processors) to access a system memory 1424 and a mass storage memory 1425.

In general, the system memory 1424 may include any desired type of volatile and/or non-volatile memory such as, for example, static random access memory (SRAM), dynamic random access memory (DRAM), flash memory, read-only memory (ROM), etc. The mass storage memory 1425 may include any desired type of mass storage device including hard disk drives, optical drives, tape storage devices, etc.

The I/O controller 1422 performs functions that enable the processor 1412 to communicate with peripheral input/output (I/O) devices 1426 and 1428 and a network interface 1430 via an I/O bus 1432. The I/O devices 1426 and 1428 may be any desired type of I/O device such as, for example, a keyboard, a video display or monitor, a mouse, etc. The network interface 1430 may be, for example, an Ethernet device, an asynchronous transfer mode (ATM) device, an 802.11 device, a digital subscriber line (DSL) modem, a cable modem, a cellular modem, etc. that enables the processor system 1410 to communicate with another processor system.

While the memory controller 1420 and the I/O controller 1422 are depicted in FIG. 14 as separate functional blocks within the chipset 1418, the functions performed by these blocks may be integrated within a single semiconductor circuit or may be implemented using two or more separate integrated circuits.

Although certain methods, apparatus, and articles of manufacture have been described herein, the scope of coverage of this disclosure is not limited thereto. To the contrary, this disclosure covers all methods, apparatus, and articles of manufacture fairly falling within the scope of the appended claims either literally or under the doctrine of equivalents.

What is claimed is:

1. A method performed by an extensible markup language (XML) document management server, the method comprising:
receiving a communication requesting an XML document from an XML document management client associated with a principal; and
generating a subset of the XML document for the principal such that validity of the subset is ensured by including all document parts required according to an XML schema despite the principal having access rights to only certain parts of the XML document but not other parts,
wherein the other parts are included in the subset without values.

2. The method of claim 1, wherein generating comprises:
supplying placeholders in the subset of the XML document, the placeholders representing the other parts for which the principal has no access rights.

3. The method of claim 2, wherein the placeholder is a blank.

4. The method of claim 2, wherein the placeholder is a value indicating a restriction or restricted access.

5. The method of claim 1, wherein the communication requesting the XML document is an XML configuration access protocol (XCAP) request.

6. The method of claim 1, wherein the XML document management server is an XML document management (XDM) server (XDMS) that is compliant with the Open Mobile Alliance (OMA) XDM Enabler specification.

7. A tangible computer readable medium storing instructions which cause a processor of a network apparatus to execute a server that performs the method of claim 1.

8. A network apparatus comprising:
a processor executing a server configured to:
receive, from an extensible markup language (XML) document management client associated with a principal, a communication requesting an XML document; and
generate a subset of the XML document for the principal such that validity of the subset is ensured by including all document parts required according to an XML schema despite the principal having access rights to only certain parts of the XML document but not other parts, wherein the other parts are included in the subset without values.

9. The apparatus of claim 8, wherein the operation to generate a subset of the XML document comprises:
supplying placeholders in the subset of the XML document, the placeholders representing the other parts for which the principal has no access rights.

10. The apparatus of claim 9, wherein the placeholder is a blank.

11. The apparatus of claim 9, wherein the placeholder is a value indicating a restriction or restricted access.

12. The apparatus of claim 8, wherein the communication requesting the XML document is an XML configuration access protocol (XCAP) request.

13. The apparatus of claim 8, wherein the XML document management server is an XML document management (XDM) server (XDMS) that is compliant with the Open Mobile Alliance (OMA) XDM Enabler specification.

14. A method performed by an extensible markup language (XML) document management client, the method comprising:
sending, to an XML document management server, a communication requesting an XML document,
wherein the communication causes the XML document management server to generate a subset of the XML document for the principal such that validity of the subset is ensured by including all document parts required according to an XML schema despite the principal having access rights to only certain parts of the XML document but not other parts, and
wherein the other parts are included in the subset without values.

15. The method of claim 14, wherein validity of the subset is ensured by supplying placeholders in the subset of the XML document, the placeholders representing the other parts for which the principal has no access rights.

16. The method of claim 15, wherein the placeholder is a blank.

17. The method of claim 15, wherein the placeholder is a value indicating a restriction or restricted access.

18. The method of claim 14, wherein the communication requesting the XML document is an XML configuration access protocol (XCAP) request.

19. The method of claim 14, wherein the XML document management client is an XML document management (XDM) client (XDMC) that is compliant with the Open Mobile Alliance (OMA) XDM Enabler specification.

20. A tangible computer readable medium storing instructions which cause a processor of a mobile communication device to execute a client that performs the method of claim 14.

21. A mobile communication device comprising:
a processor executing an XML document management client configured to send, to an XML document management server, a communication requesting an XML document,
wherein the communication causes the XML document management server to generate a subset of the XML document for the principal such that validity of the subset is ensured by including all document parts required according to an XML schema despite the principal having access rights to only certain parts of the XML document but not other parts, and
wherein the other parts are included in the subset without values.

22. The device of claim 21, wherein validity of the subset is ensured by supplying placeholders in the subset of the XML document, the placeholders representing the other parts for which the principal has no access rights.

23. The device of claim 22, wherein the placeholder is a blank.

24. The device of claim 22, wherein the placeholder is a value indicating a restriction or restricted access.

25. The device of claim 21, wherein the communication requesting the XML document is an XML configuration access protocol (XCAP) request.

26. The device of claim 21, wherein the XML document management client is an XML document management (XDM) client (XDMC) that is compliant with the Open Mobile Alliance (OMA) XDM Enabler specification.
